(19) United States
(12) Patent Application Publication
(10) Pub. No.: US 2010/0125346 A1
(43) Pub. Date: May 20, 2010

(54) PORTABLE ELECTRONIC DEVICE AND CONTROLLING METHOD THEREOF

(75) Inventor: KIM-YEUNG SIP, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/621,504

(22) Filed: Nov. 19, 2009

(30) Foreign Application Priority Data
Nov. 19, 2008 (CN) 200810305635.7

(51) Int. Cl. G05B 11/01

(52) U.S. Cl. 700/13

(57) ABSTRACT

A portable electronic device includes a plurality of function modules, a storage module, a positioning module, a processing module, and a control module. The plurality of function modules is configured for performing different functions. The storage module is configured for storing a position-locale table containing a plurality of location information, and an instruction table containing a plurality of function instructions. The positioning module is configured for receiving real time positioning signals and determining a current position of the portable electronic device according to the positioning signals. The processing module is configured for invoking one function instruction from the instruction table according to the current position and the position-locale table. The control module is configured for activating and deactivating the plurality of function modules according to the invoked function instruction.

### BACKGROUND

1. Technical Field

The present disclosure relates to controlling technology and, particularly, to a portable electronic device with changeable states.

2. Description of Related Art

Current cell phones provide the option of selecting one of a plurality of function modules. Each of the function modules may configured with one or a combination of audible alert, vibration alert, no alert, getting online, keypad tones, etc.

However, the function modules needs to be manually managed.

Therefore, what is needed is to provide a portable electronic device which can turn on/off some functions automatically according to a changed environment and a controlling method thereof.

### BRIEF DESCRIPTION OF THE DRAWINGS

The components of the drawings are not necessarily drawn to scale, the emphasis instead being placed upon clearly illustrating the principles of the embodiments of an electronic device. Moreover, in the drawings, like reference numerals designate corresponding parts throughout several views

FIG. 1 is a functional block diagram of a portable electronic device in accordance with an exemplary embodiment.

FIG. 2 is a flowchart of a control method for controlling a portable electronic device in accordance with an exemplary embodiment.

### DETAILED DESCRIPTION

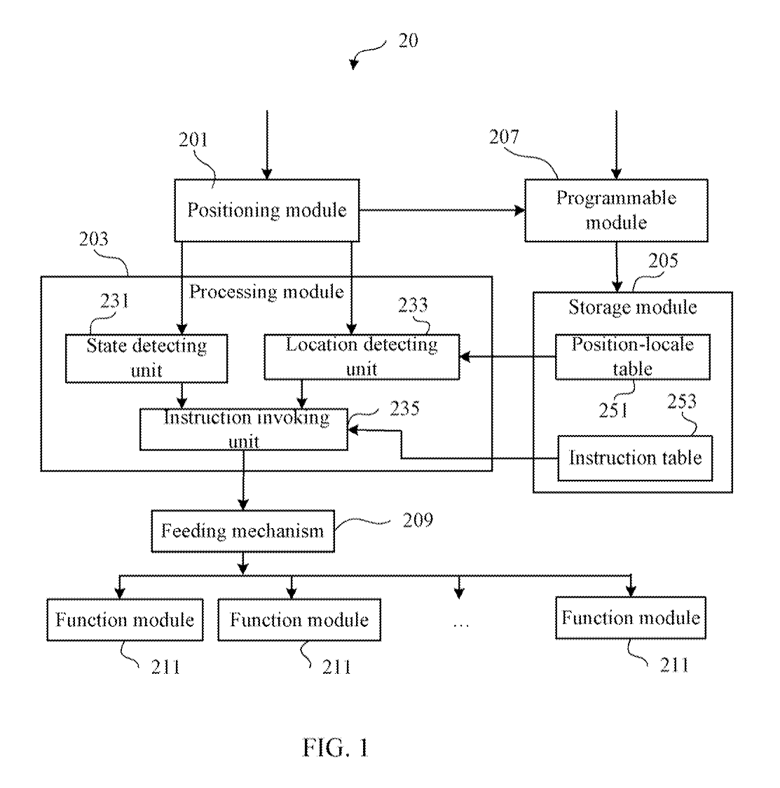

Referring to FIG. 1, a portable electronic device 20 in accordance with one embodiment is illustrated. The portable electronic device 20 includes a positioning module 201, a processing module 203, a storage module 205, a programmable module 207, a control module 209, and a plurality of function modules 211. In an embodiment, the portable electronic device 20 is a mobile phone. In other embodiments, the portable electronic device 20 also can be a personal digital assistant (PDA), a robot, or a portable electronic toy.

The plurality of function modules 211 of the portable electronic device 20 are configured for performing different functions. For example, the plurality of function modules 211 may include an audible alert module, a vibration alert, silent alert, etc. The portable electronic device 20 is capable of enabling and disabling the plurality of function modules 211 automatically according to different environments, such as a home, an office, a meeting room, etc. For example, when a user is at home with the portable electronic device 20, more functions modules 211 may be enabled. When the user is at office with the portable electronic device 20, so less function modules 211 may be enabled.

The positioning module 201 is configured for receiving real time positioning signals and determining a current position of the portable electronic device 20 according to the positioning signals. It may be understood that the real time positioning signals may be provided by a global positioning system (GPS), or a general packet radio service (GPRS).

The storage module 205 is configured for storing a position-locale table 251 and an instruction table 253. The position-locale table 251 contains a plurality of location information. The location information can be an office location, a home location, a meeting room location, a bedroom location, etc. The instruction table 253 contains a plurality of function instructions. The function instruction can be operating one or a combination of audible alert function, vibration alert function, silent alert function, etc. In an embodiment, the storage module 205 operates as a database. The storage module 205 can be a memory.

The processing module 203 is configured for invoking one function instruction from the instruction table 253 according to the current position from the positioning module 201 and the position-locale table 251 from the storage module 205. The processing module 203 includes a state detecting unit 231, a location detecting unit 233, and an instruction invoking unit 235.

The state detecting unit 231 is configured for determining a current state of the portable electronic device 20 according to the current position. The current state includes a first state and a second state. When the portable electronic device 20 is in the first state, the portable electronic device 20 is in motion, such as, the user carrying the portable electronic device 20 is moving. When the portable electronic device 20 is in the second state, the portable electronic device 20 is motionless, such as, the user of the portable electronic device 20 is stationary. In an embodiment, when the portable electronic device 20 remains in motion, the state detecting unit 231 induces that the current position in a time changes relatively quickly, or else, the current position does not change or changes slowly. In other embodiments, the state detecting unit 231 is an acceleration transducer, and a displacement transducer.

The location detecting unit 233 is further configured for determining a current location of the portable electronic device 20 according to the current position from the positioning module 201, the position-locale table 251 from the storage module 205.

The instruction invoking unit 235 is configured for invoking one function instruction from the instruction table 253 according to the current state from the state detecting unit 231, or according to the current location from the location detecting unit 233, or combination thereof.

The control module 209 is configured for activating and deactivating the plurality of function modules 211 according the invoked function instruction from the instruction invoking unit 235.

The programmable module 207 is configured for programming the position-locale table 251 according to the current position of the positioning module 201. For example, in an embodiment, when the user is at the center of the bedroom location, the positioning module 201 can determine a position of the center of the bedroom, and the programmable module 207 programs the bedroom location with an inputted approximate radial value according to the estimated size of the bedroom. In other embodiments, the positioning module 201 can determine positions for a plurality of corners of the bedroom location, and the programmable module 207 programs the bedroom location cooperated by the plurality of positions, approximately. The programmable module 207 also can program a plurality of location information, such as a car location, a washing room location, according to the needs of the user.

The programmable module 207 is further configured for programming the instruction table 253 according to the programmed position-locale table 251, and according to the user' preference. The programmable module 207 sends the programmed position-locale table 251 and the programmed instruction table 253 to the storage module 205 for storing.

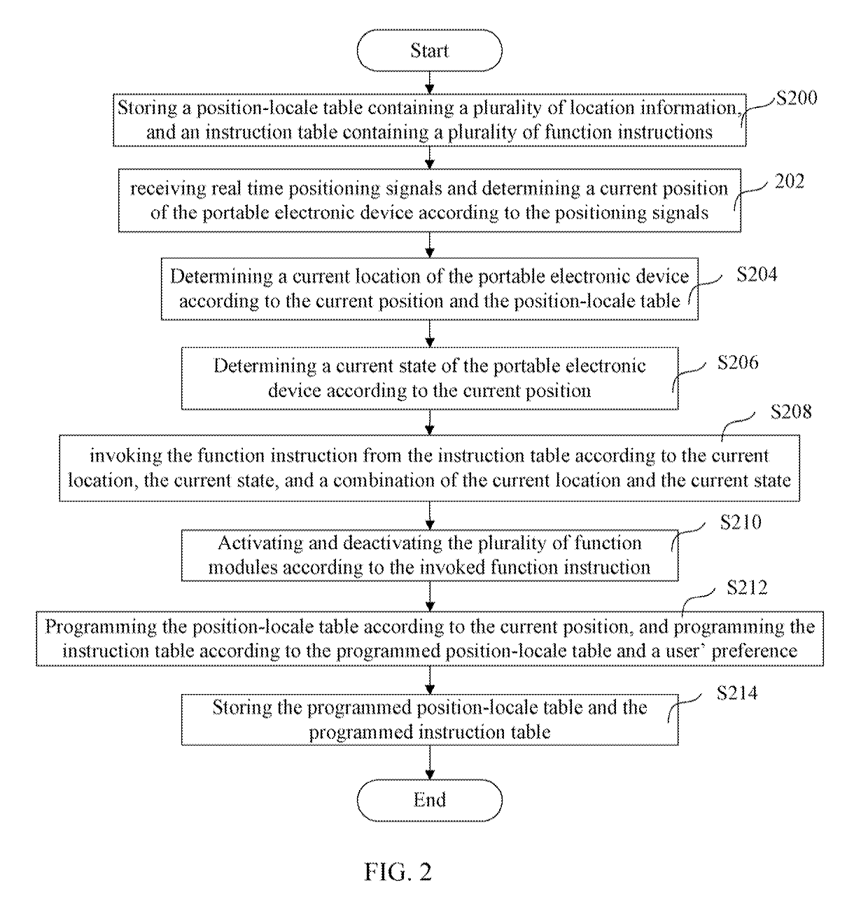

Further referring to FIG. 2, a flowchart of a controlling method for the portable electronic device 20 in accordance with an exemplary embodiment is shown. The various actions in the method may be performed in the order presented, or may be performed in a different order. Furthermore, in some embodiments, some actions shown in FIG. 2 may be omitted from the method. The method shown includes the following steps.

Beginning in step S200, storing a position-locale table containing a plurality of location information, and an instruction table containing a plurality of function instructions. The storage function is performed by the storage module 205.

In step S202, receiving real time positioning signals and determining a current position of the portable electronic device according to the positioning signals. The positioning module 201 will determines a current position when the portable electronic device 20 is at a location.

In step S204, determining a current location of the portable electronic device according to the current position and the position-locale table. The location detecting unit 233 determines the current position in which location.

In step S206, determining a current state of the portable electronic device according to the current position. The state detecting unit 231 determines whether the portable electronic device 20 is in motion or motionless.

In step S208, invoking the function instruction from the instruction table according to the current location, the current state, and a combination of the current location and the current state. The invoked function is performed by the instruction invoking unit 235.

In step S210, activating and deactivating the plurality of function modules according to the invoked function instruction.

In step S212, programming the position-locale table according to the current position, and programming the instruction table according to the programmed position-locale table and a user' preference. The position-locale table and the instruction table can be programmed by the programmable module 207.

In step S214, storing the programmed position-locale table and the programmed instruction table.

As discussed above, in operation of the portable electronic device 20, the plurality of function modules 211 can be automatically activated and deactivated by the control module 209 following the various locations.

It is to be understood, however, that even though numerous has been described with reference to particular embodiments, but the present invention is not limited to the particular embodiments described and exemplified, and the embodiments are capable of considerable variation and modification without departure from the scope of the appended claims.

What is claimed is:

1. A portable electronic device, comprising:
a plurality of function modules configured for performing different functions;
a storage module configured for storing a position-locale table containing a plurality of location information, and an instruction table containing a plurality of function instructions;
a positioning module configured for receiving real time positioning signals and determining a current position of the portable electronic device according to the positioning signals;
a processing module configured for invoking one function instruction from the instruction table according to the current position and the position-locale table; and
a control module configured for activating and deactivating the plurality of function modules according to the invoked function instruction.

2. The portable electronic device of claim 1, wherein the processing module comprises a location detecting unit and an instruction invoking unit, the location detecting unit is configured for determining a current location of the portable electronic device according to the current position and the position-locale table, and the instruction invoking unit is configured for invoking one function instruction from the instruction table according to the current location.

3. The portable electronic device of claim 2, wherein the processing module further comprises a state detecting unit, the state detecting unit is configured for determining a current state of the portable electronic device according to the current position, and the instruction invoking unit is further configured for invoking one function instruction from the instruction table according to the current state.

4. The portable electronic device of claim 2, wherein the instruction invoking unit is further configured for invoking one function instruction from the instruction table according to a combination of the current location and the current state.

5. The portable electronic device of claim 4, wherein the current state of the portable electronic device comprises a first state and a second state, when in first state, the portable electronic device is in motion, and when in second state, the portable electronic device is motionless.

6. The portable electronic device of claim 1, further comprising a programmable module configured for programming the position-locale table according to the current position and sending the programmed position-locale table to the storage module for storing.

7. The portable electronic device of claim 6, wherein the programmable module is further configured for programming the instruction table according to the programmed position-locale table and a user' preference, and sending the programmed instruction table to the storage module for storing.

8. A portable electronic device, comprising:
a plurality of function modules configured for performing different functions;
a storage module configured for storing an instruction table containing a plurality of function instructions;
a positioning module configured for receiving real time positioning signals and determining a current position of the portable electronic device according to the positioning signals;
a state detecting unit configured for determining a current state of the portable electronic device according to the current position;
an instruction invoking unit configured for invoking one function instruction from the instruction table according to the current state; and
a control module configured for activating and deactivating the plurality of function modules according to the invoked function instruction.

9. The portable electronic device of claim 8, wherein the current state of the portable electronic device comprises a first state and a second state, when in first state, the portable electronic device is in motion, and when in second state, the portable electronic device is motionless.

10. The portable electronic device of claim 9, further comprising a programmable module configured for programming the instruction table according to a user' preference and sending the programmed instruction table to the storage module for storing.

11. A controlling method for controlling a portable electronic device to perform different functions automatically, the portable electronic device comprising a plurality of function modules configured for performing different functions, the controlling method comprising:
storing a position-locale table containing a plurality of location information, and an instruction table containing a plurality of function instructions;
receiving real time positioning signals and determining a current position of the portable electronic device according to the positioning signals;
invoking one function instruction from the instruction table according to the current position and the position-locale table; and
activating and deactivating the plurality of function modules according to the invoked function instruction.

12. The controlling method of claim 11, wherein the invoking step comprises:
determining a current location of the portable electronic device according to the current position and the position-locale table; and
invoking the function instruction from the instruction table according to the current location.

13. The controlling method of claim 12, wherein the invoking step further comprises:
determining a current state of the portable electronic device according to the current position; and
invoking the function instruction from the instruction table according to the current state.

14. The controlling method of claim 13, wherein the invoking step further comprises:
invoking the function instruction from the instruction table according to a combination of the current location and the current state.

15. The controlling method of claim 14, wherein the current state of the portable electronic device comprises a first state and a second state, when in the first state, the portable electronic device is in motion, and when in second state, the portable electronic device is motionless.

16. The controlling method of claim 11, wherein the controlling method further comprises:
programming the position-locale table according to the current position and sending the programmed position-locale table for storing.

17. The controlling method of claim 16, wherein the programming step further comprises:
programming the instruction table according to the programmed position-locale table and a user' preference, and sending the programmed instruction table for storing.
